(19) United States
(12) Patent Application Publication
(10) Pub. No.: US 2026/0106650 A1
(43) Pub. Date: Apr. 16, 2026

(54) MULTIPLE USER - MULTIPLE INPUT, MULTIPLE OUTPUT (MU-MIMO) SCENARIOS

(71) Applicant: T-Mobile USA, Inc., Bellevue, WA (US)

(72) Inventors: Gaviphat Lekutai, Kirkland, WA (US); George Cummings, Gilbert, AZ (US); John J. Humbert, Roeland Park, KS (US); Jun Liu, Issaquah, WA (US)

(73) Assignee: T-Mobile USA, Inc., Bellevue, WA (US)

(21) Appl. No.: 19/355,760

(22) Filed: Oct. 10, 2025

Related U.S. Application Data
(60) Provisional application No. 63/706,375, filed on Oct. 11, 2024.

(51) Int. Cl. H04B 7/0452; H04L 5/00; H04W 72/21

(52) U.S. Cl. CPC H04B 7/0452; H04L 5/0048; H04W 72/21

(57) ABSTRACT

Techniques for configuring multiple input, multiple (MIMO) operation in a network are discussed herein. In some examples, techniques can include sending channel status information reference signal(s) to one or more user equipments (UEs) in an environment. The UE(s) can respond with parameter(s) indicative of radio frequency conditions at the UE(s). In some examples, the UE(s) can send sounding reference signal (SRS) data to a base station. A computing device can receive the parameter(s) and can input the parameters to a model (e.g., a machine learned model) trained to determine configuration data for configuring a base station for MIMO operation. In some examples, the base station can be configured for single user MIMO (SU-MIMO) or multiple user MIMO (MU-MIMO).

### CROSS-REFERENCE TO RELATED APPLICATIONS

This application claims priority to U.S. Provisional Patent Application Number 63/706,375 entitled “Machine Learning Techniques in Multiple User – Multiple Input, Multiple Output (MU-MIMO) Scenarios,” filed October 11, 2024, which is incorporated herein by reference in its entirety.

### BACKGROUND

Cellular communication devices use network radio access technologies to communicate wirelessly with geographically distributed cellular base stations. Long-Term Evolution (LTE) is an example of a widely implemented radio access technology that is used in 4^{th} Generation (4G) communication systems. New Radio (NR) is a newer radio access technology that is used in 5^{th} Generation (Fifth Generation, or 5G) communication systems. Standards for LTE and NR radio access technologies have been developed by the 3rd Generation Partnership Project (3GPP) for use by wireless communication carriers.

Some base stations use multiple input, multiple output (MIMO) send data to devices. In general, MIMO is a wireless technology uses multiple transmitters and receivers to transfer more data at the same time.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates example environments illustrating various scenarios for single user -multiple input, multiple output (SU-MIMO) operation and multiple user - multiple input, multiple output (MU-MIMO) operation, in accordance with aspects of the disclosure.

FIG. 2 illustrates an example computing device configured to determine parameter(s) for use in SU-MIMO and/or MU-MIMO operation(s), in accordance with aspects of the disclosure.

FIG. 3 illustrates an example process for configuring a device for MIMO operation, in accordance with aspects of the disclosure.

FIG. 4 illustrates another example process for configuring a device for MIMO operation, in accordance with aspects of the disclosure.

FIG. 5 illustrates example details for configuring a device for MIMO operation, in accordance with aspects of the disclosure.

FIG. 6 illustrates example details for configuring a device for MIMO operation based on CSI-RS, in accordance with aspects of the disclosure.

FIG. 7 illustrates example details for configuring a device for MIMO operation based on SRS, in accordance with aspects of the disclosure.

### DETAILED DESCRIPTION

One key performance metric of a wireless communication system is its spectral efficiency, namely, the extent of data that the system can carry per unit of frequency spectrum. The spectral efficiency of a wireless communication system or its base stations could be measured as a quantity of bits per Hertz.

If a wireless communication system has low spectral efficiency, a provider of the system may need to configure the system with additional licensed spectrum, such as wider carriers and/or more carriers, in order to accommodate communication needs. However, adding licensed spectrum could be costly and therefore may be undesirable.

One way to help improve spectral efficiency is to make use of multiple input, multiple output (MIMO) technology.

With MIMO, a base station can engage in air interface communication concurrently on multiple different radio-frequency (RF) propagation paths, or MIMO “layers,” with multiple layers occupying the same frequency resources (e.g., subcarriers and physical resource blocks (PRBs)) as each other. To facilitate this, the base station could be equipped with a MIMO antenna array, comprising multiple transmit antennas and multiple receive antennas. By suitably weighting and precoding transmissions by particular antennas in the array, the base station can then output spatially separate but concurrent transmissions for receipt by its served user equipments (UEs). Because these concurrent transmissions occupy the same frequency resources (e.g., subcarriers) as each other, MIMO can thereby support a greater extent of data communication per unit frequency, thereby increasing the base stations’ spectral efficiency and possibly avoiding or deferring the need to add more spectrum.

MIMO service could be used in a “single-user MIMO” (SU-MIMO) configuration to increase the data rate of transmission to a single UE, by multiplexing communications to the UE onto multiple separate layers using the same air-interface resources as each other. In practice, the UE could have two or more antennas, and the UE can estimate the channel distortion at each of its antennas and use the estimates to separately compute and uncover each of the base station’s transmit signals.

Further, MIMO can also be used in a “multi-user MIMO” (MU-MIMO) configuration to increase the data capacity of the air interface by allowing communications to multiple UEs to use the same air-interface resources as each other. For instance, a base station can modulate data streams destined to each of multiple UEs on the same PRBs as each other and can transmit the modulated data streams on a separate respective propagation paths for receipt by the UEs. To facilitate this, the base station can pre-code transmissions on each propagation path using weighted coefficients based on channel estimates from the UEs, in a manner that enables each UE to remove cross-talk and receive its intended data. Further, the base station can beamform the transmissions respectively to each UE to help physically distinguish the transmissions from each other. In some examples, MU-MIMO operation can thus increase the data capacity of the air interface by allowing a base station to serve more UEs at a time without requiring additional air-interface resources.

In general, 3GPP has defined two types of codebooks for Fifth Generation / New Radio (5G/NR) implementations, Type I and Type II. In some examples, Type I (Type 1) can be used for single users (SU-MIMO) or multiple users (MU-MIMO) and Type II (Type 2) can be used for MU-MIMO.

In some examples, a base station can send a Channel Status Information (or Channel State Information) (CSI) Reference Signal (RS) to devices in an environment. A UE (or multiple UEs) can receive the CSI-RS and can measure the characteristics of a radio channel so that the UE can use the correct modulation, code rate, beam forming, etc. The UE can receive the CSI-RS and can determine characteristics of the downlink channel. For example, the UE can receive CSI-RS and can determine one or more of Channel Quality Information (CQI), channel state information (CSI) parameters such as precoding matrix indicator (PMI), rank indicator (RI), and the like. In some examples, the UE may receive CSI-RS and may determine CSI amplitude and phase information, interference or noise estimates, layer mapping recommendations (e.g., Type 1 / Type 2 parameters), and the like. In some examples, the UE may send information to the base station as Channel Quality Information (CQI) reports.

In general, and in some examples, the base station can receive feedback from the UE(s) to allow the gNB to determine a proper PMI and/or beam forming information to either SU or MU-MIMO users, and schedule downlink (DL) data transmissions with appropriate Modulation, Coding Schemes (MCS) and MIMO layer back to the UE.

In some examples, the base station can receive the CQI reports from the UE (or multiple UEs) and can determine beam(s) for Type 1 and/or Type 2 implementation. In some examples, the base station can determine to use Type 1 or Type 2 based on a number of factors, including but not limited a number of UEs being served by a base station, a location of one or more UEs relative to the base station (e.g., one UE near the base station may use Type 1, while as distance increases or a number of UEs increase, the base station may use Type 2 MIMO), noise or interference levels, and the like. In some examples, a base station may not have Type 1 or Type 2 activated (e.g., based on licensing status), and in some examples, if both Type 1 and Type 2 are available to the base station, the base station may use Type 2 for MU-MIMO.

In some examples, the base station can send or receive a variety of information to or from the UE, including but not limited to: sounding reference signals (SRS); channel status information reference signals (CSI-RS); Precoding Matrix Indicator (PMI); rank indication (RI); CSI-RS resource indicator (CRI); power class (PC) information; current transmission power setting(s) (or level(s)) (e.g., which may be less than maximum transmit power); reference signal received power (RSRP); signal-to-interference-plus-noise ratio (SINR); synchronization signal (SSB); layers; location; time; velocity (e.g., UE velocity); etc.

In some examples, the base station can output or otherwise determine data (e.g., using a machine learned model) that may be used to configure a base station and/or UE for Type 1 or Type 2 MIMO. In some examples, the base station can output or determine data including, but not limited to, beam indicator(s) / beam index (indices) / beam number(s); precoding matrix indicator (PMI); sounding reference signal (SRS); layers; location; time; velocity; etc.

In some examples, a base station can send out a grid of beams with information identifying each beam. A UE can receive a beam of the grid of beams and can respond with Sounding Reference Signals (SRS) to the base station. In some examples, the base station can configure the base station to transmit to the UE with a MIMO operation based on the received SRS.

In some examples, the base station can receive the SRS from one or more UEs and can input the SRS data into a machine learned model to determine one or more parameters for MIMO (SU or MU) operation.

In some examples, the base station can receive one or more inputs described above and output or otherwise determine one or more outputs. In some examples, a base station can use, include, or otherwise comprise a machine learning model to output or otherwise determine the outputs based on one or more inputs.

In some examples, such a machine learning may include a neural network, a convolutional neural network (CNN), a recurrent neural network (RNN), a model with one or more long-short term memory (LSTM) layers, a model using one or more Gated Recurrent Unit (GRU) layers, a generative model, a large language model, a reinforcement learning algorithm, a supervised learning algorithm, an unsupervised learning algorithm, deep forest algorithms, random forest algorithms, etc.

In some examples, a base station can be configured with one or more machine learning model models to determine Type 1 and/or Type 2 parameters. In some examples, the machine learning model can be trained using training data gathered based on Type 1 operation, Type 2 operation, or MIMO operation based on SRS. In some examples, the machine learning model can be configured to approximate the output of a Type 2 calculation whereby an output of the model can be used as input to determine Type 1 parameters for MIMO operation.

In some examples, a machine learning model can output parameters to enable Type 1 operation. In some examples, the machine learning model can receive one or more of a RI data (e.g., rank: the number of layers), a PMI (e.g., a codebook index), a MCS (modulation coding scheme), and/or requested or target power split across layers. In some examples, the machine learning model can be trained based on training data that can map channel state data to output rank, precoder, and modulation coding schemes. In some examples, the training data can include simulation data that chooses RI, PMI, and/or MCS and maximizes throughput to UEs, or from log data annotated with a best performing configuration.

In some examples, a machine learning model can output parameters to enable Type 2 operation. In some examples, the machine learning model may use some or all of the inputs and/or outputs that a machine learning model may use to determine Type 1 parameters as well as training data that maps CSI feedback with context about neighboring users, beam identifiers and interference data. In some examples, the training data can include simulated data or log data that maps configuration parameters with resulting performance metrics. In some examples, training data can include positive examples (e.g., mapping parameters to good performance) and negative examples (e.g., mapping parameters to bad performance).

In some examples, a UE can include one or more models, such as a machine learned model, to determine channel information to provide back to a base station, which can in turn determine parameters for MIMO (MU or SU). That is, in some examples, one or more devices (e.g., UE, base station, core network node, etc.) can implement one or more machine learned models to determine parameters for SU-MIMO and/or MU-MIMO operation(s).

In some examples, the techniques discussed herein can use artificial intelligence and machine learning that can provide the benefits of CSI-RS MU-MIMO Type II (e.g., MU-MIMO user pairing) but implemented onto CSI-RS MU-MIMO Type I with its existing Type I codebook parameters. In addition to existing Type I parameters, a machine learning model can take into account of the UE power information (power class, UE max transmit power, current UE transmit power, etc.) as part of the machine learning model to model the Type II algorithm to provide the proper beam amplitude towards the particular UE, then convert the information back to match with Type I codebook parameters.

Accordingly, in some examples, the techniques discussed herein can reduce processing at the UE and/or the base station to reduce the processing complexity and/or signaling required to implement SU-MIMO or MU-MIMO in a network environment. Accordingly, the techniques can improve a functioning of one or more computing devices and/or reduce network congestion, thereby providing practical improvements and practical applications of the techniques discussed herein. Further, the techniques discussed herein improve bandwidth to one or more UEs, thereby improving network performance. Further, implementing MIMO operations can reduce congestion and interference with other devices on a network (e.g., by beamforming). These and other improvements to UEs and the network are discussed herein.

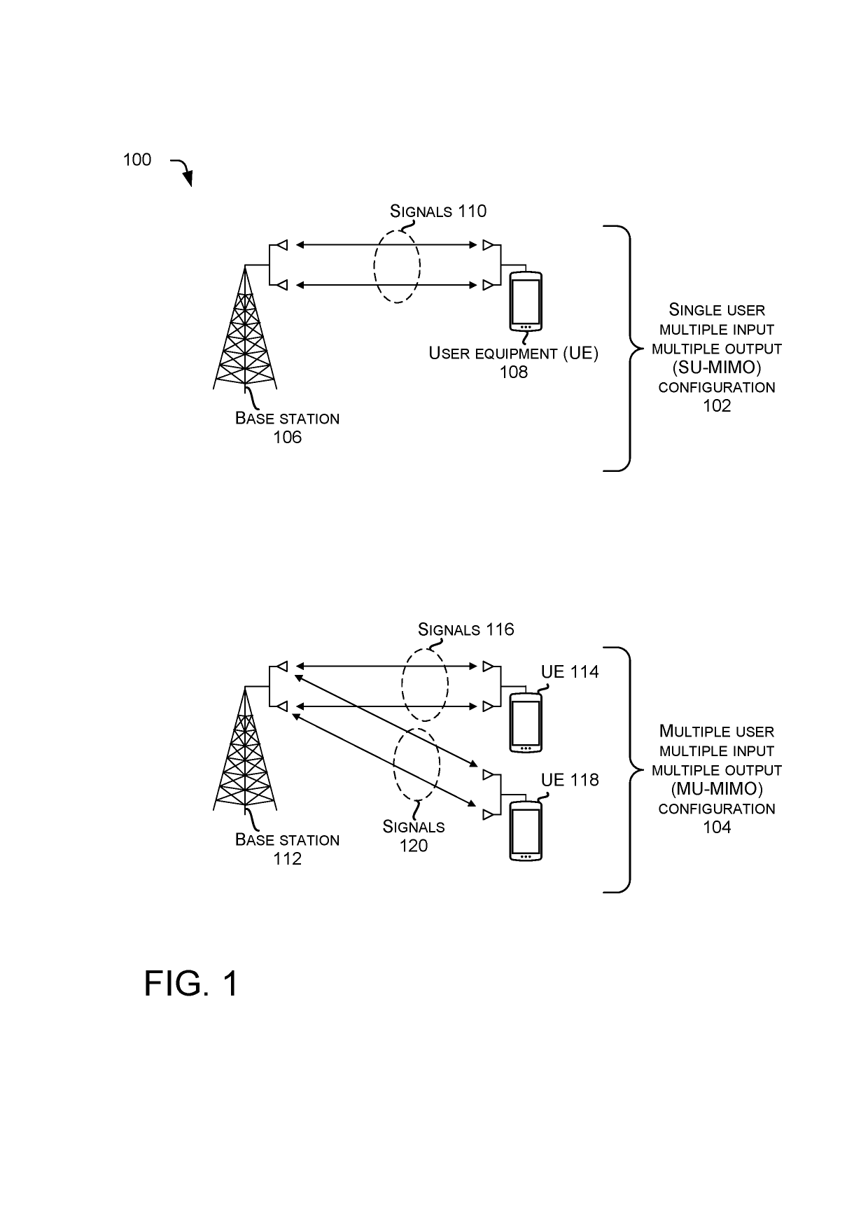

FIG. 1 illustrates an example 100 of environments illustrating various scenarios for single user -multiple input, multiple output (SU-MIMO) operation and multiple user - multiple input, multiple output (MU-MIMO) operation, in accordance with aspects of the disclosure.

As illustrated, FIG. 1 shows a single user - multiple input, multiple output (SU-MIMO) configuration 102 and multiple – user, multiple input multiple output (MU-MIMO) configuration 104. The SU-MIMO configuration 102 includes a base station 106 in communication with a user equipment 108 via signals 110. As illustrated, the base station 106 includes multiple antennas sending and/or receiving the signals 110 to multiple antennas associated with the UE 108. Accordingly, the SU-MIMO operation 102 represents a wireless technique where multiple antennas at the transmitter and receiver are used to serve one user device (e.g., the UE 108) at a time.

FIG. 1 also illustrates the MU-MIMO configuration 104, which includes a base station 112 in communication with a UE 114 via signals 116. As illustrated, the base station 112 includes multiple antennas sending and/or receiving the signals 116 to multiple antennas associated with the UE 114. As further illustrated, the MU-MIMO 104 includes the base station 112 in communication with a UE 118 via signals 120. In some examples, the UE 118 may include multiple antennas such that the signals 120 include multiple input and/or multiple outputs to the UE118, and in some examples, the UE 118 may include a single antenna and/or the signals 120 may include a single stream to facilitate communication between the base station 112 and the UE 118. In some examples, the MU-MIMO operation 104 can represent a wireless technique where the transmitter (e.g., the base station 112) uses multiple antennas to serve multiple user devices (e.g., the UEs 114 and 118) at the same time on the same frequency resources.

In some examples, the SU-MIMO operation 102 can be implemented as Type 1 MIMO operation and the MU-MIMO operation 104 can be implemented as Type 2 MIMO in accordance with at least 3GPP TS 38.214 v. 18.3.0, section 5.2.2.2.3. Further, the SU-MIMO operation 102 and/or the MU-MIMO operation 104 can be implemented in accordance with the techniques discussed herein. In some examples, the MU-MIMO operation can be implemented as either a Type 1 or Type 2 operation. In some examples, the MIMO operation can be based on SRS.

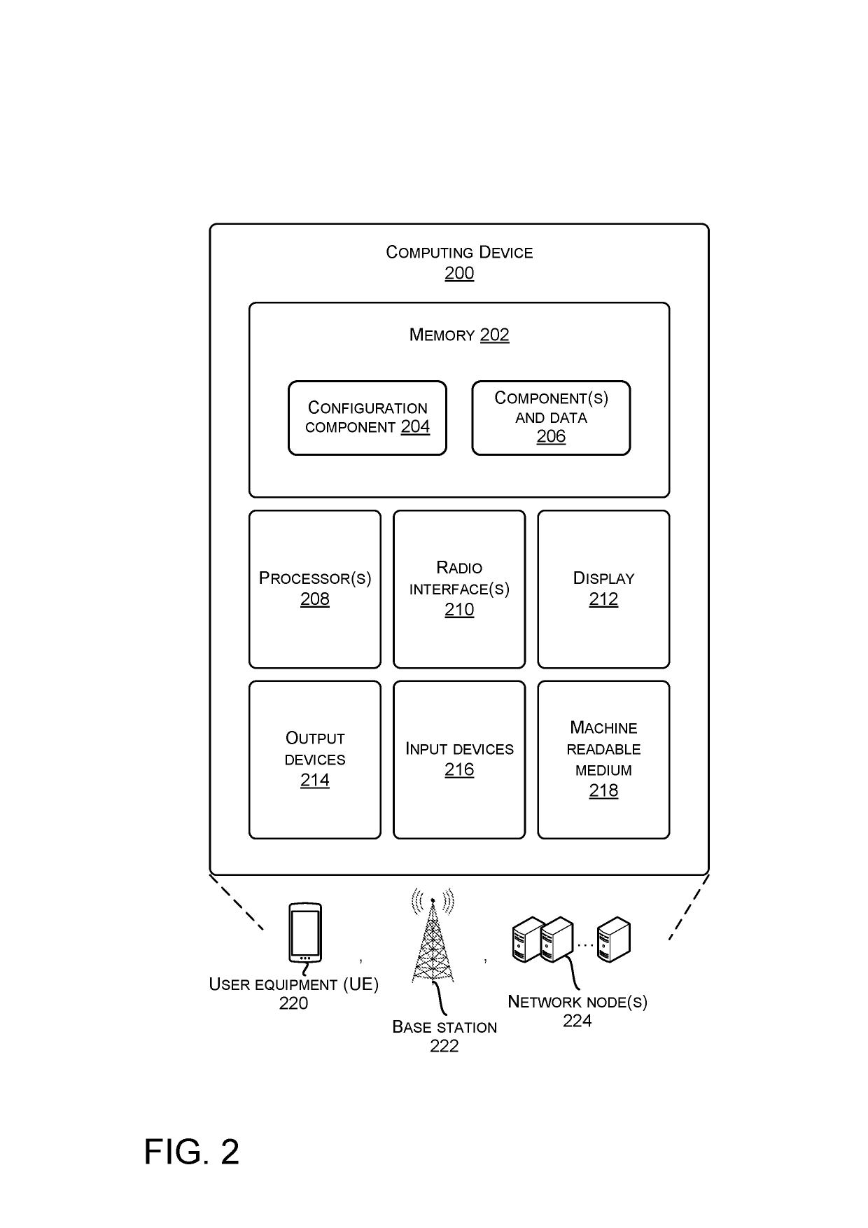

FIG. 2 illustrates an example computing device 200 configured to determine parameter(s) for use in SU-MIMO and/or MU-MIMO operation, in accordance with aspects of the disclosure. It is to be understood in the context of this disclosure that the computing device 200 can be implemented as a single device, as a plurality of devices, or as a system with components and data distributed among them.

In some examples, the computing device 200 can be implemented as a user equipment (UE) 220, as a base station (e.g., a gNB) 222, network node(s) 224, and the like.

In some examples, the UE 220 can comprise any of various types of wireless cellular communication devices that are capable of wireless data and/or voice communications, including smartphones and other mobile devices, “Internet-of-Things” (IoT) devices, smart home devices, computers, wearable devices, entertainment devices, industrial control equipment, etc. Further examples can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over a network.

In general, the UE 220 can include any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VoLTE, Institute of Electrical and Electronics Engineers’ (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The UE 220 can implement enhanced Mobile Broadband (eMBB) communications, Ultra Reliable Low Latency Communications (URLLCs), massive Machine Type Communications (mMTCs), and the like. In some examples, the UE 220 can communicate via any terrestrial (e.g., ground-based) and/or non-terrestrial (e.g., satellite) base stations.

In some examples, the base station 222 can comprise one or more of an eNodeB (eNB), a gNodeB (gNB), and the like. In some examples, the base station 222 can be any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VoLTE, Institute of Electrical and Electronics Engineers’ (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The base station 222 can implement enhanced Mobile Broadband (eMBB) communications, Ultra Reliable Low Latency Communications (URLLCs), massive Machine Type Communications (mMTCs), and the like. In some examples, the base station 222 can be any terrestrial (e.g., ground-based) and/or non-terrestrial (e.g., satellite) base station.

In some examples, the base stations 106 and/or 112 can correspond to the base station 222.

In some examples, the UE 220 and/or the base station 222 can utilize a 4G radio technology. The UE 220 and/or the base station 222 may transmit and receive data via a connection (e.g., at least one LTE radio link) that is defined according to frequency bands included in, but not limited to, a range of 450 MHz to 5.9 GHz. In some instances, the frequency bands utilized for the base station 222 can include, but are not limited to, LTE Band 1 (e.g., 2100 MHz), LTE Band 2 (1900 MHz), LTE Band 3 (1800 MHz), LTE Band 4 (1700 MHz), LTE Band 5 (850 MHz), LTE Band 7 (2600 MHz), LTE Band 8 (900 MHz), LTE Band 20 (800 MHz GHz), LTE Band 28 (700 MHz), LTE Band 38 (2600 MHz), LTE Band 41 (2500 MHz), LTE band 48 (e.g., 3500 MHz (the CBRS band)), LTE Band 50 (1500 MHz), LTE Band 51 (1500 MHz), LTE Band 66 (1700 MHz), LTE Band 70 (2000 MHz), LTE Band 71 (e.g., a 600 MHz band), LTE Band 74 (1500 MHz), and the like. In some examples, the base station 222 can be, or at least include, an eNodeB.

In some instances, the UE 220 and/or the base station 222 can also utilize a 5G radio technology, such as technology specified in the 5G NR standard, as defined by 3GPP. In certain implementations, the UE 220 and/or the base station 222 can transmit and receive communications with devices over a connection (e.g., at least one NR radio link) that is defined according to frequency resources including but not limited to 5G Band 1 (e.g., 2080 MHz), 5G Band 2 (1900 MHz), 5G Band 3 (1800 MHz), 5G Band 4 (1700 MHz), 5G Band 5 (850 MHz), 5G Band 7 (2600 MHz), 5G Band 8 (900 MHz), 5G Band 20 (800 MHz), 5G Band 28 (700 MHz), 5G Band 38 (2600 MHz), 5G Band 41 (2500 MHz), NR Band 48 (e.g., 3500 MHz (the CBRS band)), 5G Band 50 (1500 MHz), 5G Band 51 (1500 MHz), 5G Band 66 (1700 MHz), 5G Band 70 (2000 MHz), 5G Band 71 (e.g., a 600 MHz band), 5G Band 74 (1500 MHz), 5G Band 77 (e.g., C-Band 3.7 GHz), 5G Band 257 (28 GHz), 5G Band 258 (24 GHz), 5G Band 260 (39 GHz), 5G Band 261 (28 GHz), and the like. In some examples, the base station 222 can be, or at least include, a gNodeB.

FIG. 2 also shows a single UE 220 (also referred to as a cellular communication device 220 or a device 220), which may be one of many such devices that are configured for use with the techniques discussed herein. In the described example, the UE 220 supports both 4G/LTE and 5G/NR networks and communications. Further, in the described examples, the UE 220 supports both terrestrial networks and non-terrestrial networks.

In some examples, the network node (s) 224 can include a 4G core network and/or a 5G core network.

In some examples, the network node (s) 224 can include a 4G core network comprising a Mobility Management Entity (MME), a Serving Gateway (SGW), a Packet Data Network (PDN) Gateway (PGW), a Home Subscriber Server (HSS), an Access Network Discovery and Selection Function (ANDSF), an evolved Packet Data Gateway (ePDG), and the like.

In some examples, the network node (s) 224 can include a 5G core network comprising any of an Access and Mobility Management Function (AMF), a Session Management Function (SMF), a Policy Control Function (PCF), an Application Function (AF), an Authentication Server Function (AUSF), a Network Slice Selection Function (NSSF), a Unified Data Management (UDM), a Network Exposure Function (NEF), a Network Repository Function (NRF), a User Plane Function (UPF), and the like.

As illustrated, the computing device 200 comprises a memory 202 storing a configuration component 204 and/or component(s) and data 206. Also, the computing device 200 can include a processor(s) 208, radio interface(s) 210, a display 212, output devices 214, input devices 216, and/or a machine readable medium 218.

In various implementations, the memory 202 is volatile (such as RAM), non-volatile (such as ROM, flash memory, etc.) or some combination of the two. The configuration component 204 and/or the component(s) and data 206 stored in the memory 202 can comprise instructions for executing or implementing methods (e.g., computer-implemented method), threads, processes, applications or any other sort of executable instructions. The configuration component 204 and/or the component(s) and data 206 can also include files and databases.

In general, the configuration component 204 can include functionality to determine data for configuring MIMO and/or for configuring one or more devices for MIMO operation. In some examples, the configuration component 204 can include one or more models, such as machine learning models, to determine configuration data and/or to configure devices for MIMO operation.

In general, the component(s) and data 206 can be utilized by the computing device 200 to perform or enable performing any action taken by the computing device 200. The components and data 206 can include a UE, base station, or network node platform, operating system, and applications, and data utilized by the platform, operating system, and applications.

In various examples, the processor(s) 208 can be a central processing unit (CPU), a graphics processing unit (GPU), or both CPU and GPU, or any other type of processing unit. Each of the one or more processor(s) 208 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 208 may also be responsible for executing all computer applications stored in the memory 202, which can be associated with common types of volatile (RAM) and/or nonvolatile (ROM) memory.

As noted above, in some examples, the processor(s) 208 can include, but are not limited to, a graphics processing unit (GPU), an Artificial Intelligence (AI) accelerator, a deep learning processor, a neural processing unit (NPU), and the like.

The radio interfaces 210 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 210 can be compatible with multiple radio access technologies, such as 5G radio access technologies and 4G/LTE radio access technologies. Accordingly, the radio interfaces 210 can allow the computing device 200 to connect to various components as described herein. In some examples, the radio interfaces 210 can include a cellular radio component, a short-range wireless communication component, a Wi-Fi component, and the like.

The display 212 can be a liquid crystal display or any other type of display commonly used in computing devices. For example, display 212 may be a touch-sensitive display screen, and can then also act as an input device or keypad, such as for providing a soft-key keyboard, navigation buttons, or any other type of input. The output devices 214 can include any sort of output devices known in the art, such as the display 212, speakers, a vibrating mechanism, and/or a tactile feedback mechanism. Output devices 214 can also include ports for one or more peripheral devices, such as headphones, peripheral speakers, and/or a peripheral display. The input devices 216 can include any sort of input devices known in the art. For example, input devices 216 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 218 can store one or more sets of instructions, such as software or firmware, that embodies any one or more of the methodologies or functions described herein. The instructions can also reside, completely or at least partially, within the memory 202, processor(s) 208, and/or radio interface(s) 210 during execution thereof by the computing device 200. The memory 202 and the processor(s) 208 also can constitute machine readable media 218.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

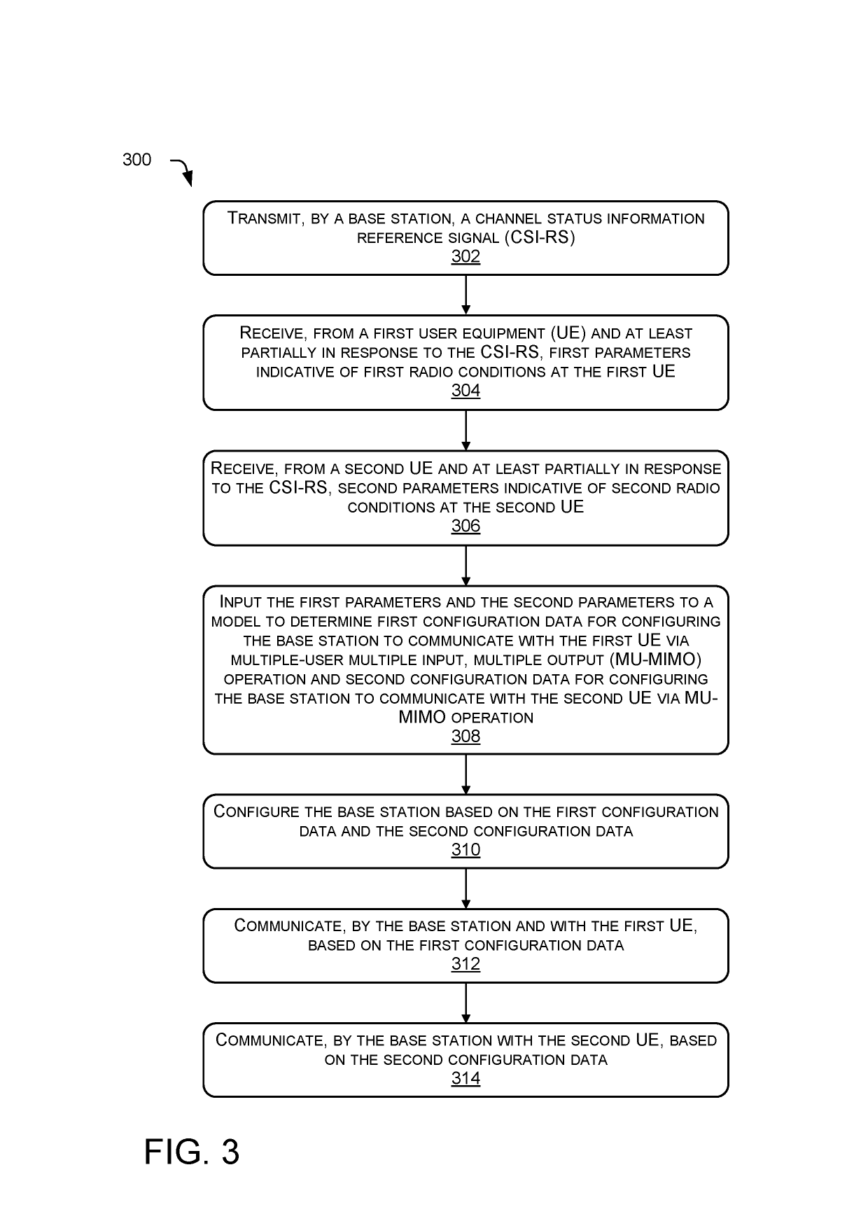

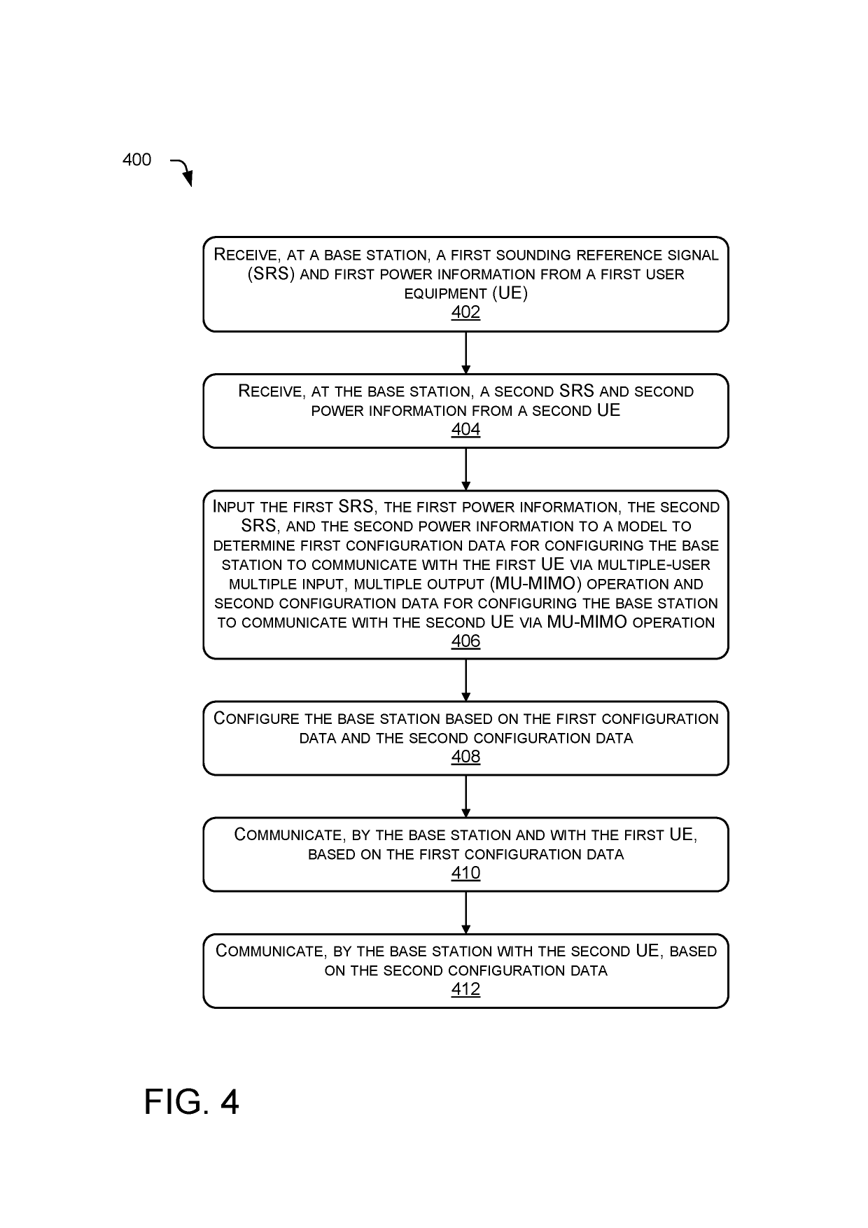

FIGS. 3 and 4 illustrate example processes in accordance with examples of the disclosure. These processes are illustrated as logical flow graph(s), each operation of which represents a sequence of operations that can be implemented in hardware, software, or a combination thereof. In the context of software, the operations represent computer-executable instructions stored on one or more (non-transitory) computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted, combined in any order, and/or combined in parallel to implement the processes.

FIG. 3 illustrates an example process 300 for configuring a device for MIMO operation, in accordance with aspects of the disclosure. The example process 300 can be performed by the base station 222 (and/or another component), in connection with other components and/or devices discussed herein. Some or all of the process 300 can be performed by one or more computing devices 200 or components in an environment, for example.

At operation 302, the process can include transmitting, by a base station, a channel status information reference signal (CSI-RS). As can be understood, the operation 302 can include transmitting the CSI-RS as a general broadcast such that the signal can be received by multiple UEs. However, in some examples, the base station can configure which UEs should monitor which specific CSI-RS resources via RRC (resource reconfiguration command) signaling.

At operation 304, the process can include receiving, from a first user equipment (UE) and at least partially in response to the CSI-RS, first parameters indicative of first radio conditions at the first UE. In some examples, the first parameters may include, but are not limited to, channel state information (CSI) or channel quality information (CQI). In some examples, the first parameters can include, but are not limited to, one or more of CQI, PMI, RI, CSI amplitude and phase information, interference or noise estimates, layer mapping recommendation (e.g., in Type 1 / Type 2 codebooks), and the like.

At operation 306, the process can include receiving, from a second UE and at least partially in response to the CSI-RS, second parameters indicative of second radio conditions at the second UE. In some examples, the second parameters may include, but are not limited to, channel state information (CSI) or channel quality information (CQI). In some examples, the second parameters can include, but are not limited to, one or more of CQI, PMI, RI, CSI amplitude and phase information, interference or noise estimates, layer mapping recommendation (e.g., in Type 1 / Type 2 codebooks), and the like.

At operation 308, the process can include inputting the first parameters and the second parameters to a model to determine first configuration data for configuring the base station to communicate with the first UE via multiple-user multiple input, multiple output (MU-MIMO) operation and second configuration data for configuring the base station to communicate with the second UE via MU-MIMO operation.

In some examples, the operation 308 can include inputting the first parameters and the second parameters to the model in parallel, or substantially simultaneously, within technical tolerances. The model (e.g., a machine learning model) can be configured to receive the inputs at roughly the same time, or substantially simultaneously, so that it can produce an output based on both inputs together. In this example, the model processes the two sets of data in parallel to combine the information internally to determine the relationship between the first and second parameters and how they affect the final outcome. In some examples, this allows the model to make more accurate or context-aware predictions than if it considered either set of parameters alone.

In some examples, the operation 308 can include outputting first and second configuration data. In some examples, the first configuration data and/or the second configuration data may include, but are not limited to, one or more of a beam indicator, a beam index, a beam number, precoding matrix indicator (PMI), layer information, precoding matrix, rank, modulation scheme, and the like.

At operation 310, the process can include configuring the base station based on the first configuration data and the second configuration data. In some examples, the operation 310 can include configuring the base station for MU-MIMO operation.

At operation 312, the process can include communicating, by the base station and with the first UE, based on the first configuration data.

At operation 314, the process can include communicating, by the base station with the second UE, based on the second configuration data. In some examples, the operation 312 and 314 can collectively include MU-MIMO operations in accordance with the techniques discussed herein.

FIG. 4 illustrates another example process 400 for configuring a device for MIMO operation, in accordance with aspects of the disclosure. The example process 400 can be performed by the base station 222 (and/or another component), in connection with other components and/or devices discussed herein. Some or all of the process 400 can be performed by one or more computing devices 200 or components in an environment, for example.

At operation 402, the process can include receiving, at a base station, a first sounding reference signal (SRS) and first power information (e.g., power class information and/or current transmission power setting) from a first user equipment (UE). In some examples, the SRS can be in response to a request from the base station, and in some examples, the SRS can be sent periodically by the UE. In some examples, the base station can configure the SRS via a RRC signal. In some examples, the power information can represent power class information, such as PC1, PC1.5, PC2, PC4, PC5, and the like.

At operation 404, the process can include receiving, at the base station, a second SRS and second power information (e.g., power class information and/or current transmission power setting) from a second UE.

At operation 406, the process can include inputting the first SRS, the first power information, the second SRS, and/or the second power information to a model to determine first configuration data for configuring the base station to communicate with the first UE via multiple-user multiple input, multiple output (MU-MIMO) operation and second configuration data for configuring the base station to communicate with the second UE via MU-MIMO operation. In some examples, the first and/or second configuration data can include, but is not limited to, one or more of a beam indicator, a beam index, a beam number, or layer information.

In some examples, the operation 406 can include, but is not limited to, one or more of selecting beam(s) and/or precoders for the UE(s), deciding the feasible rank (e.g., the number of spatial layers), groups of UEs for MU-MIMO operation, selecting antenna directions or configurations for downlink MIMO, and the like.

In some examples, the base station can use the SRS from each UE to estimate the uplink channel matrix, which, in turn, can be used to estimate the downlink channel matrix (e.g., the base station can estimate downlink operations based on the received SRS).

At operation 408, the process can include configuring the base station based on the first configuration data and the second configuration data. As can be understood, the operation 408 can included configuring the base station to operate in a MU-MIMO configuration.

At operation 410, the process can include communicating, by the base station and with the first UE, based on the first configuration data.

At operation 412, the process can include communicating, by the base station with the second UE, based on the second configuration data. In some examples, the operation 410 and 412 can collectively include MU-MIMO operations in accordance with the techniques discussed herein.

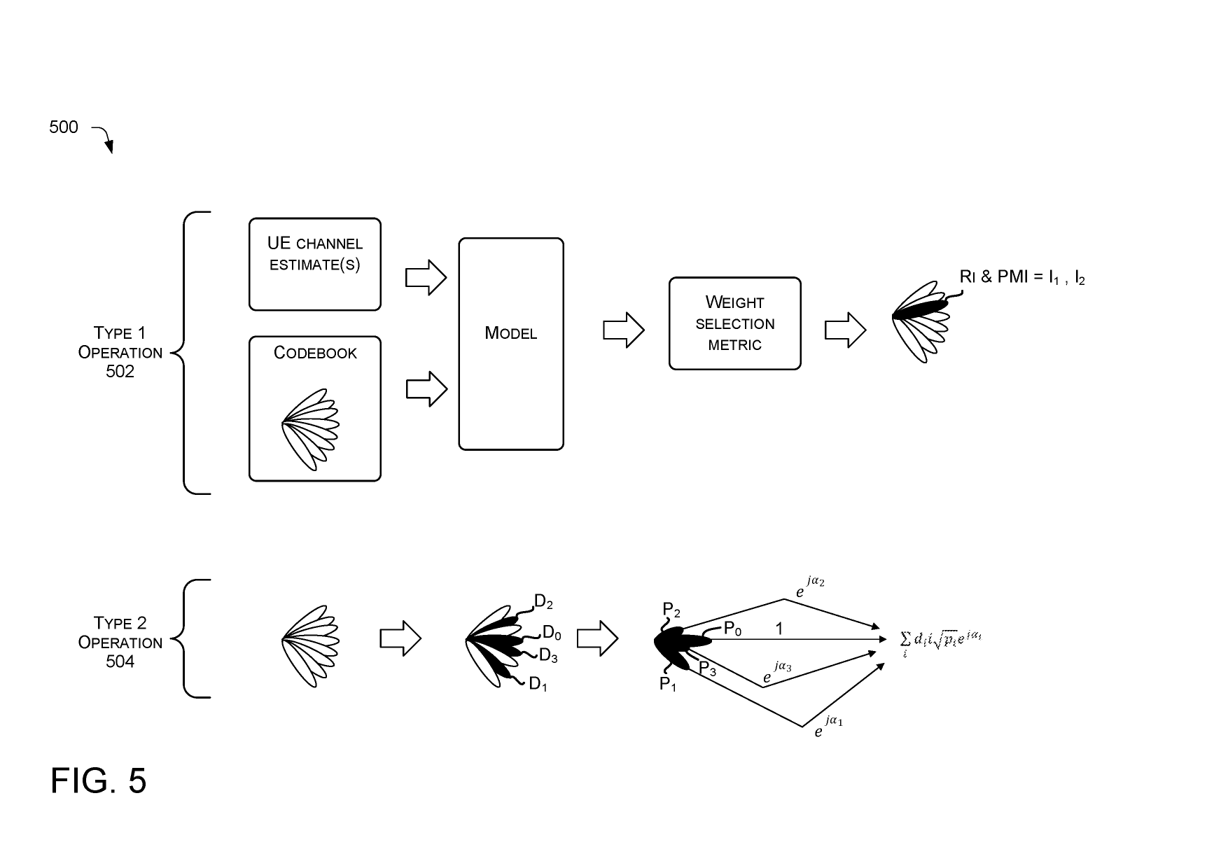

FIG. 5 illustrates example 500 for configuring a device for MIMO operation, in accordance with aspects of the disclosure.

FIG. 5 illustrates Type 1 operation 502 for determining first MIMO operations and Type 2 operation 504 for determining second MIMO operations. In some examples, the Type 1 operation 502 can include determining channel estimates and inputting the channel estimates and a codebook into a model, which can determine weight selection metric(s), which can be used to select a particular beam and parameters for that beam. In some examples, the parameters can include a rank indication (RI) and/or a Precoding Matrix Indicator (PMI) for enabling MIMO operations. Other parameters are discussed throughout the disclosure as well.

In some examples, the Type 2 operation 504 can include choosing L orthogonal beams, determining beam power scaling, and determining beam co-phasing. In some examples, the UE may provide high resolution CSI feedback to enable the Type 2 operation 504.

In some examples, the techniques can use artificial intelligence / machine learning techniques to guide the UE in estimating MU-MIMO channels based on the transmitted CSI-RS, which may then feed RI and PMI back to a base station (e.g., a gNB).

In some examples, the Type 1 operation 502 may include selecting one specific beam (e.g., based on UE location) from a group of beams, whereas in some examples, the Type 2 operation 504 can include selecting a group of beams and linearly combining the selected beams within the group.

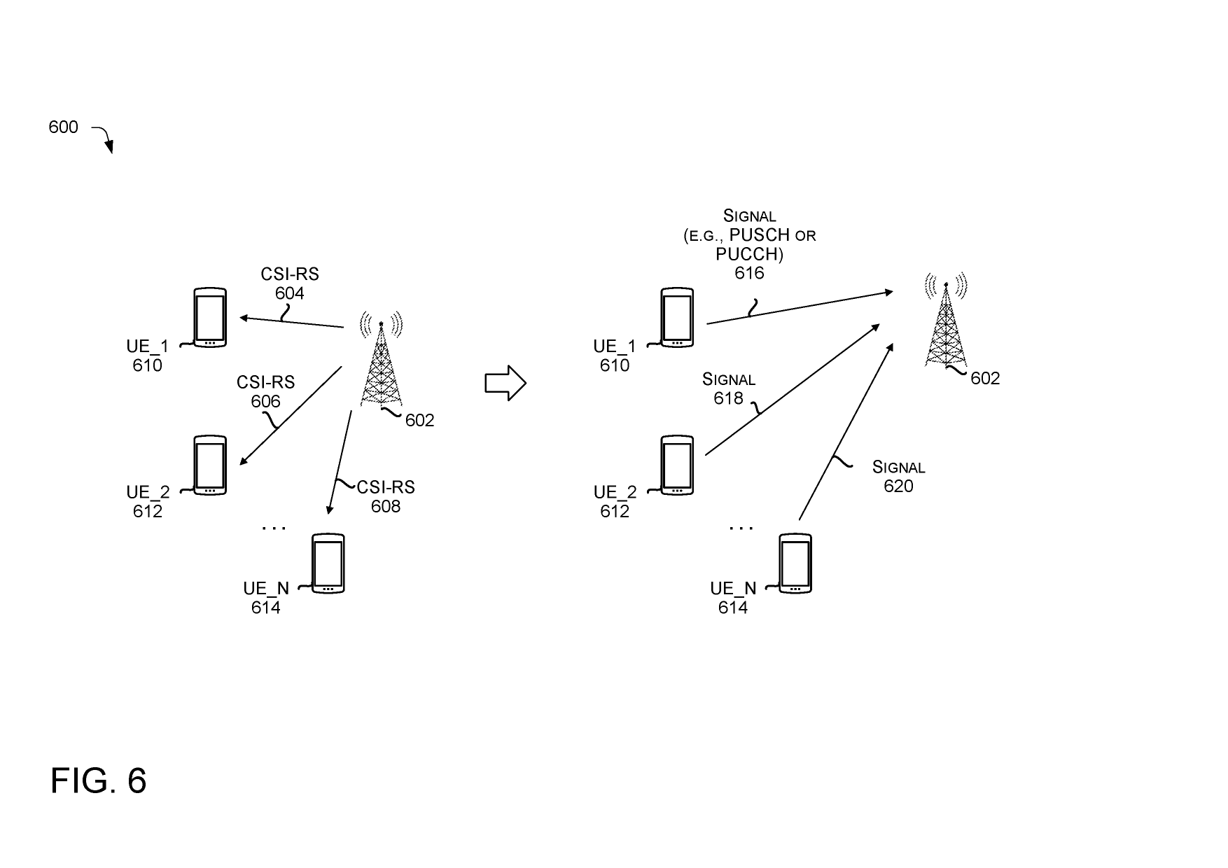

FIG. 6 illustrates example 600 for configuring a device for MIMO operation based on CSI-RS, in accordance with aspects of the disclosure.

In some examples, the base station (e.g., base station 602) in example 600 can send channel state information reference signal(s) (CSI-RS) (e.g., CSI-RS 604, CSI-RS 606, CSI-RS 608) to one or more UEs (e.g., UE_1 610, UE_2 612, UE_N 614) in an environment. The UEs can respond with precoding matrix information (PMI) (or other parameters discussed herein) and the base station can input the PMI (and/or other parameters) to a model trained to determine parameters for MU-MIMO (e.g., amplitude data, phase data, horizontal and/or vertical beam angles, and the like).

In some examples, the UEs can send the PMI information to the base station via respective signals 616, 618, and/or 620. In some examples, such signals 616, 618, and/or 620 can represent a PUSCH (physical uplink shared channel) or PUCCH (physical uplink control channel). In some examples, the signals 616, 618, and/or 620 can be sent aperiodically (e.g., via the PUSCH) or periodically (e.g., via the PUCCH). In some examples, the PMI/CQI/RI data may require two or more resource blocks when sending such data.

In some examples, the base station can include a model that can predict parameters for Type 2 MU-MIMO. In some examples, the model can predict Type 2 parameters and can map the parameters back to Type 1 MIMO. In some examples, the machine learned model can predict Type 2 parameters based on received UE information (e.g., PMI, power class, location, and the like), and can output parameters (e.g., amplitude data, phase data, horizontal and/or vertical beam angles, and the like) for implementing Type 2 MIMO at the base station.

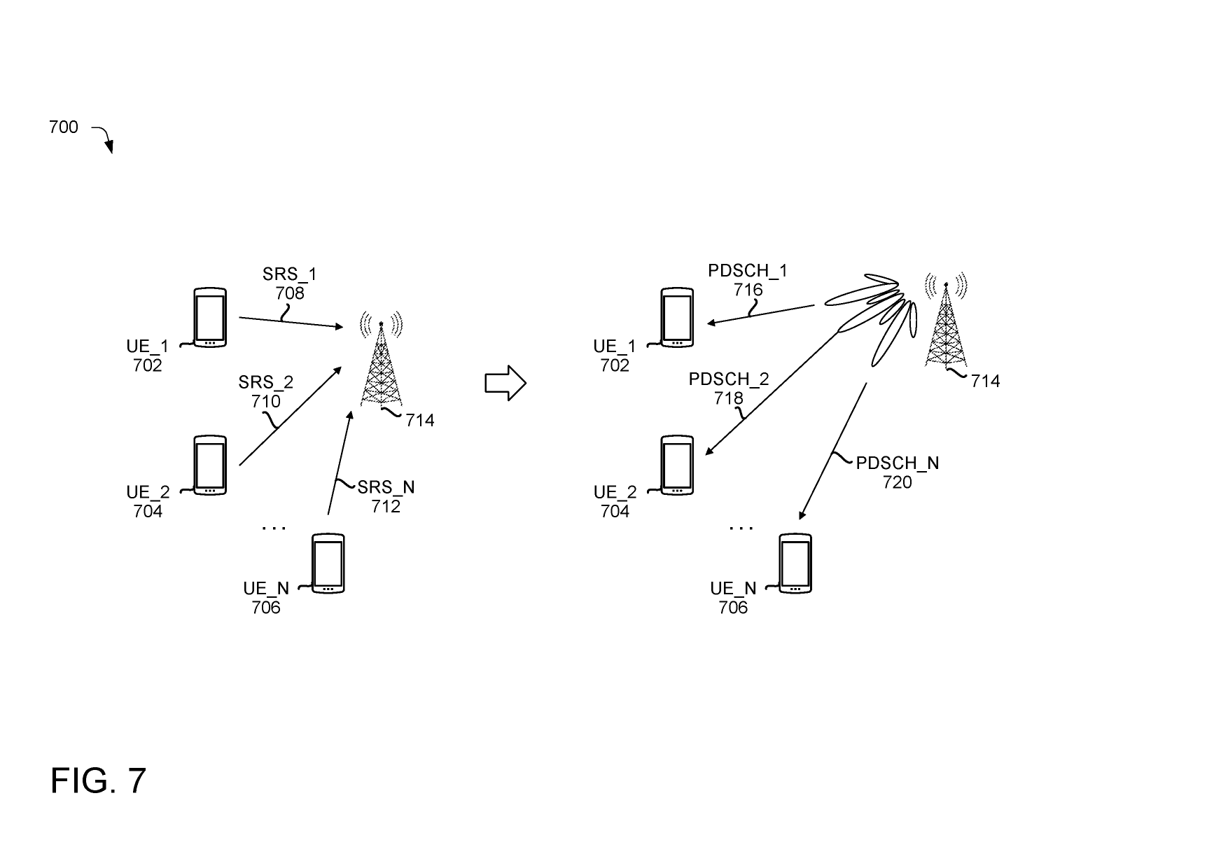

FIG. 7 illustrates example 700 for configuring a device for MIMO operation based on SRS, in accordance with aspects of the disclosure.

In some examples, the example 700 illustrates various UEs (e.g., a UE_1702, a UE_2704, a UE_N 706) sending sounding reference signals (SRS) (e.g., SRS_1708, SRS_2710, and SRS_N 712) to the base station (e.g., a gNB, such as base station 714)). In some examples, the base station may also know information about the UE, such as a power class associated with each individual UE (e.g., determined when the UE attaches to a base station). In some examples, the base station can comprise a model, such as a machine learned model, that can receive, as input, the SRS from one or more UEs, the power class for the one or more UEs, location data, and/or other information. In some examples, the model can output MU-MIMO parameters (e.g., amplitude data, phase data, horizontal and/or vertical beam angles, and the like), which can be used to implement MU-MIMO operation at the gNB for the one or more UEs in the example 400.

In some examples, the model in the base station can assign different beam power and/or angles based on the SRS, power class, and/or other information from the UE.

In some examples, some or all of the UEs can send location data to the base station (and/or the base station can determine location information). In some examples, the location data can be based on GPS data from UEs, an uplink angle of arrival, and/or an uplink time of arrival. As noted above, the location data can be input to the model to determine MU-MIMO parameters.

In some examples, the model at the base station can also determine MU-MIMO parameters based on history data (e.g., for particular location(s) of UEs in an environment), path loss data, power class data, angle of lobe(s), and the like.

In some examples, when the base station has a sufficient number of antennas, the base station may beamform a plurality of physical downlink shared channel (PDSCH) transmissions (e.g., PDSCH_1716, PDSCH_2718, and PDSCH_N 720).

In some examples, a machine learned model configured to implement the techniques discussed herein can enhance MU-MIMO by assigning different transmit power based on the location and/or angle of UEs relative to the base station. In some examples, the UE transmit power requirements can be mapped onto the UE based on the MU-MIMO beamforming weight calculation (also referred to as MU-MIMO beamforming weight estimation) and/or based on the UE power class availability.

### Example Clauses

A: A method comprising: transmitting, by a base station, a channel status information reference signal (CSI-RS); receiving, from a first user equipment (UE) and at least partially in response to the CSI-RS, first parameters indicative of first radio conditions at the first UE; receiving, from a second UE and at least partially in response to the CSI-RS, second parameters indicative of second radio conditions at the second UE; inputting the first parameters and the second parameters to a model to determine first configuration data for configuring the base station to communicate with the first UE via multiple-user multiple input, multiple output (MU-MIMO) operation and second configuration data for configuring the base station to communicate with the second UE via the MU-MIMO operation; configuring the base station based on the first configuration data and the second configuration data; communicating, by the base station and with the first UE, based on the first configuration data; and communicating, by the base station with the second UE, based on the second configuration data.

B: The method of paragraph A, wherein the model is a machine learned model that is trained based on training data gathered using Type 1 MIMO operation.

C: The method of paragraph A or B, wherein the model is a machine learned model that is trained based on training data gathered using Type 2 MIMO operation.

D: The method of any of paragraphs A–C, wherein the model is a machine learned model that is trained based on training data gathered using sounding reference signal (SRS) feedback.

E: The method of any of paragraphs A–D, wherein at least one of the first parameters or the second parameters comprise channel state information (CSI) or channel quality information (CQI).

F: The method of any of paragraphs A–E, wherein at least one of the first configuration data or the second configuration data includes one or more of a beam indicator, a beam index, a beam number, precoding matrix indicator (PMI), a sounding reference signal (SRS), or layer information.

G: The method of any of paragraphs A–F, wherein the first parameters are received via a physical uplink shared channel (PUSCH) or a physical uplink control channel (PUCCH).

H: The method of any of paragraphs A–G, wherein configuring the base station based on the first configuration data and the second configuration data comprises selecting a group of beams and linearly combining beams within the group of beams.

I: The method of any of paragraphs A–H, further comprising inputting the first parameters and the second parameters substantially simultaneously into the model.

J: A system comprising: one or more processors; and one or more non-transitory computer-readable media storing computer executable instructions that, when executed, cause the one or more processors to perform operations comprising: transmitting, by a base station, a channel status information reference signal (CSI-RS); receiving, from a first user equipment (UE) and at least partially in response to the CSI-RS, first parameters indicative of first radio conditions at the first UE; receiving, from a second UE and at least partially in response to the CSI-RS, second parameters indicative of second radio conditions at the second UE; inputting the first parameters and the second parameters to a model to determine first configuration data for configuring the base station to communicate with the first UE via multiple-user multiple input, multiple output (MU-MIMO) operation and second configuration data for configuring the base station to communicate with the second UE via the MU-MIMO operation; configuring the base station based on the first configuration data and the second configuration data; communicating, by the base station and with the first UE, based on the first configuration data; and communicating, by the base station with the second UE, based on the second configuration data.

K: The system of paragraph J, wherein the model is a machine learned model that is trained based on at least one of: first training data gathered using Type 1 MIMO operation; second training data gathered using Type 2 MIMO operation; or third training data using sounding reference signal (SRS) feedback.

L: The system of paragraph J or K, wherein at least one of the first parameters or the second parameters comprise channel state information (CSI) or channel quality information (CQI).

M: The system of any of paragraphs J–L, wherein at least one of the first configuration data or the second configuration data includes one or more of a beam indicator, a beam index, a beam number, precoding matrix indicator (PMI), a sounding reference signal (SRS), or layer information.

N: The system of any of paragraphs J–M, wherein the base station is a Fifth Generation base station configured to communicate via the MU-MIMO operation.

O: The system of any of paragraphs J–N, wherein the first parameters are received via a physical uplink shared channel (PUSCH) or a physical uplink control channel (PUCCH).

P: The system of any of paragraphs J–O, wherein configuring the base station based on the first configuration data and the second configuration data comprises selecting a group of beams and linearly combining beams within the group of beams.

Q: A method comprising: receiving, at a base station, a first sounding reference signal (SRS) from a first user equipment (UE) in an environment; receiving, at the base station, first power information associated with the first UE; receiving, at the base station, a second SRS from a second UE in the environment; receiving, at the base station, second power information associated with the second UE; inputting the first SRS, the second SRS, the first power information, and the second power information to a model to determine first configuration data for configuring the base station to communicate with the first UE via multiple-user multiple input, multiple output (MU-MIMO) operation and second configuration data for configuring the base station to communicate with the second UE via the MU-MIMO operation; configuring the base station based on the first configuration data and the second configuration data; communicating, by the base station and with the first UE, based on the first configuration data; and communicating, by the base station with the second UE, based on the second configuration data.

R: The method of paragraph Q, wherein the power information is indicative of a power class of the first UE and a current transmission power setting of the first UE.

S: The method of paragraph Q or R, wherein at least one of the first configuration data or the second configuration data includes one or more of a beam indicator, a beam index, a beam number, or layer information.

T: The method of any of paragraphs Q–S, wherein the base station is a Fifth Generation base station configured to communicate via the MU-MIMO operation.

While the example clauses described above are described with respect to one particular implementation, it should be understood that, in the context of this document, the content of the example clauses can also be implemented via a method, device, system, computer-readable medium, and/or another implementation. Additionally, any of examples A–T may be implemented alone or in combination with any other one or more of the examples A–T.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is

1. A method comprising:
transmitting, by a base station, a channel status information reference signal (CSI-RS);
receiving, from a first user equipment (UE) and at least partially in response to the CSI-RS, first parameters indicative of first radio conditions at the first UE;
receiving, from a second UE and at least partially in response to the CSI-RS, second parameters indicative of second radio conditions at the second UE;
inputting the first parameters and the second parameters to a model to determine first configuration data for configuring the base station to communicate with the first UE via multiple-user multiple input, multiple output (MU-MIMO) operation and second configuration data for configuring the base station to communicate with the second UE via the MU-MIMO operation;
configuring the base station based on the first configuration data and the second configuration data;
communicating, by the base station and with the first UE, based on the first configuration data; and
communicating, by the base station with the second UE, based on the second configuration data.

2. The method of claim 1, wherein the model is a machine learned model that is trained based on training data gathered using Type 1 MIMO operation.

3. The method of claim 1, wherein the model is a machine learned model that is trained based on training data gathered using Type 2 MIMO operation.

4. The method of claim 1, wherein the model is a machine learned model that is trained based on training data gathered using sounding reference signal (SRS) feedback.

5. The method of claim 1, wherein at least one of the first parameters or the second parameters comprise channel state information (CSI) or channel quality information (CQI).

6. The method of claim 1, wherein at least one of the first configuration data or the second configuration data includes one or more of a beam indicator, a beam index, a beam number, precoding matrix indicator (PMI), a sounding reference signal (SRS), or layer information.

7. The method of claim 1, wherein the first parameters are received via a physical uplink shared channel (PUSCH) or a physical uplink control channel (PUCCH).

8. The method of claim 1, wherein configuring the base station based on the first configuration data and the second configuration data comprises selecting a group of beams and linearly combining beams within the group of beams.

9. The method of claim 1, further comprising inputting the first parameters and the second parameters substantially simultaneously into the model.

10. A system comprising:
one or more processors; and
one or more non-transitory computer-readable media storing computer executable instructions that, when executed, cause the one or more processors to perform operations comprising:
transmitting, by a base station, a channel status information reference signal (CSI-RS);
receiving, from a first user equipment (UE) and at least partially in response to the CSI-RS, first parameters indicative of first radio conditions at the first UE;
receiving, from a second UE and at least partially in response to the CSI-RS, second parameters indicative of second radio conditions at the second UE;
inputting the first parameters and the second parameters to a model to determine first configuration data for configuring the base station to communicate with the first UE via multiple-user multiple input, multiple output (MU-MIMO) operation and second configuration data for configuring the base station to communicate with the second UE via the MU-MIMO operation;
configuring the base station based on the first configuration data and the second configuration data;
communicating, by the base station and with the first UE, based on the first configuration data; and
communicating, by the base station with the second UE, based on the second configuration data.

11. The system of claim 10, wherein the model is a machine learned model that is trained based on at least one of:
first training data gathered using Type 1 MIMO operation;
second training data gathered using Type 2 MIMO operation; or
third training data using sounding reference signal (SRS) feedback.

12. The system of claim 10, wherein at least one of the first parameters or the second parameters comprise channel state information (CSI) or channel quality information (CQI).

13. The system of claim 10, wherein at least one of the first configuration data or the second configuration data includes one or more of a beam indicator, a beam index, a beam number, precoding matrix indicator (PMI), a sounding reference signal (SRS), or layer information.

14. The system of claim 10, wherein the base station is a Fifth Generation base station configured to communicate via the MU-MIMO operation.

15. The system of claim 10, wherein the first parameters are received via a physical uplink shared channel (PUSCH) or a physical uplink control channel (PUCCH).

16. The system of claim 10, wherein configuring the base station based on the first configuration data and the second configuration data comprises selecting a group of beams and linearly combining beams within the group of beams.

17. A method comprising:
receiving, at a base station, a first sounding reference signal (SRS) from a first user equipment (UE) in an environment;
receiving, at the base station, first power information associated with the first UE;
receiving, at the base station, a second SRS from a second UE in the environment;
receiving, at the base station, second power information associated with the second UE;
inputting the first SRS, the second SRS, the first power information, and the second power information to a model to determine first configuration data for configuring the base station to communicate with the first UE via multiple-user multiple input, multiple output (MU-MIMO) operation and second configuration data for configuring the base station to communicate with the second UE via the MU-MIMO operation;
configuring the base station based on the first configuration data and the second configuration data;
communicating, by the base station and with the first UE, based on the first configuration data; and
communicating, by the base station with the second UE, based on the second configuration data.

18. The method of claim 17, wherein the power information is indicative of a power class of the first UE and a current transmission power setting of the first UE.

19. The method of claim 17, wherein at least one of the first configuration data or the second configuration data includes one or more of a beam indicator, a beam index, a beam number, or layer information.

20. The method of claim 17, wherein the base station is a Fifth Generation base station configured to communicate via the MU-MIMO operation.
